(19) United States
(12) Patent Application Publication
(10) Pub. No.: US 2007/0132126 A1
(43) Pub. Date: Jun. 14, 2007

(54) Method for debundling and dispersing carbon fiber filaments uniformly throughout carbon composite compacts before densification

(76) Inventors: Richard L. Shao, North Royalton, OH (US); Terrence A. Pirro, Cleveland, OH (US)

Correspondence Address: WADDEY & PATTERSON, P.C., 1600 DIVISION STREET, SUITE 500, NASHVILLE, TN, 37203, US

(21) Appl. No.: 11/300,690

(22) Filed: Dec. 14, 2005

(51) Int. Cl. C01B 31/00

(52) U.S. Cl. 264/29.1

(57) ABSTRACT

A method of forming a carbon fiber reinforced carbon composite articles includes the steps of: (a) selecting carbon fiber bundles that have a sizing material that is soluble in a selected dispersing fluid; (b) mixing the selected carbon bundles and other blend components in a dispersing fluid so as to debundle the carbon fibers and to produce a slurry of blend components in which the individual carbon fibers are substantially randomly oriented and uniformly distributed throughout; and (c) removing the dispersing fluid either prior to or during the process of forming of the solids of the slurry into a carbon fiber reinforced carbon composite article having individual carbon fibers substantially randomly oriented and uniformly distributed throughout.

We, Richard L. Shao, a citizen of the United States, residing at 12731 North Star Drive, North Royalton, Ohio; and Terrence A. Pirro, a citizen of the United States, residing at 3169 West 11th Street, Cleveland, Ohio have invented a new and useful “Method for Debundling and Dispersing Carbon Fiber Filaments Uniformly Throughout Carbon Composite Compacts Before Densification.”

### BACKGROUND OF THE INVENTION

1. Technical Field

The present invention relates to compositions and methods of making carbon fiber reinforced carbon composites. More particularly, the present invention relates to compositions and methods of making carbon fiber reinforced carbon composites having a substantially uniform distribution of randomly oriented carbon fiber filaments.

2. Background Art

Carbon fibers are widely used in composite articles to improve specific properties of bulk composite products. For example, carbon fibers are frequently embedded in polymer, metal, ceramic or carbon matrices to improve such properties as bulk tensile strength, bulk weight, coefficient of thermal expansion (CTE), stiffness, and temperature stability of the composite product. Useful carbon fibers include: pitch-based carbon fibers, mesophase pitch-based carbon fibers, isotropic pitch-based carbon fibers, polyacrylonitrile-based carbon fibers, and rayons. When mixed with blend components, these carbon fibers are embedded in matrix materials, such as pitches, phenols and furans, and molded into green or precursor composite articles. These green articles are then formed into carbon composites by means of curing, thermosetting, carbonization, densification and graphitization as desired.

Of particular industrial interest are carbon fiber reinforced carbon composites. Certain carbon fiber reinforced carbon composites are useful in forming lightweight composite articles having high temperature stability, strength, stiffness, hardness, toughness and crack resistance. For example, pitch-based carbon fibers have been used in graphitized carbon fiber reinforced carbon composites compacts to form such articles as: brake components; antiskid components; structural components, such as body panels; pistons and cylinders, for vehicles, such as aircraft, high performance cars, trains, and aerospace vehicles; and missile components.

Other carbon fiber reinforced carbon composites are also widely used in bulk graphite products. For example, carbon fibers have been used to improve specific properties of electrodes and pins. In British Patent 1,526,809 to Lewis and Singer, between 50% and 80% by weight of mesophase pitch-based carbon fibers are added to between 20% and 50% by weight of pitch binder and then extruded to from a carbon composite article that can be graphitized. The graphitized composite exhibits low electrical resistivity and low longitudinal CTE. In U.S. Pat. No. 6,280,663 and in U.S. Patent Application 2004/0041291, both to Shao et. al., carbon fibers derived from mesophase pitch or polyacrylonitrile PAN are added to other blend components, including coke and a liquid pitch binder, in an amount between about 0.4% and about 10% by weight of total components to form an electrodestock blend for extruding to form a green electrodestock. After extrusion, carbonization, densification and graphitization, the resultant carbon fiber reinforced carbon composite article exhibited a substantial reduction in longitudinal CTE and a marked increase in Young's modulus and flexural strength.

During fabrication of such bulk graphite products, the carbon fibers are added to the blend as carbon fiber bundles bound and compacted with the use of a sizing material. The carbon bundles used in these bulk graphite products contain from about 2000 to about 20,000 carbon fibers (or filaments). However, the carbon fibers are generally not individually dispersed into the blend but maintained in a bundled form.

Optimizing both the amount of carbon fibers individually embedded in the matrix material and the average length of those individual fibers would be of particular industrial interest in maximizing the reinforcement properties of the carbon fiber reinforcement of the composite. Theoretically, the maximum reinforcement effect of carbon fibers can be achieved by ensuring complete and uniform dispersal of randomly oriented individual carbon fibers throughout the carbon composite article (herein also termed full dispersion) while maintaining the original lengths of the fibers. Past attempts to fully disperse carbon fibers were directed at mixing the fiber bundles with the other component parts of the blend by mechanical agitation until the fibers were debundled and dispersed in the blend as individual fibers. However, a significant draw back of mechanical agitation is that the mixing process tends to break individual fibers as well as mechanically debundle the fibers from the carbon fiber bundle. Such reduction in fiber length adversely affects the reinforcement properties of the carbon fibers. Thus, these prior art methods require a significant tradeoff between the amount of debundling, the degree of dispersal of the fibers and the amount of reduction in fiber length. This tradeoff is disadvantageous in composites having carbon fibers added at lower levels, as measured by percentage weight of total blend components and is particularly disadvantageous where carbon fibers are added at about 1% to about 3% by weight of total blend components. At such low concentrations of carbon fibers, the carbon fiber bundles are not completely separated into individual fibers in the resulting blend.

A different approach was taught by Shao et. al in U.S. Pat. No. 6,395,220 as a process for making graphite pins. In a specific embodiment, mesophase pitch-based carbon fibers were compacted with a sizing material into bundles of approximately 12,000 carbon fibers each and were then chopped into ¼ inch lengths. The weight percentage of the carbon fibers was 3.2% of the total blend components. The carbon fiber bundles were blended in a cylinder mixer with a molten pitch binder so as to first disperse the carbon fibers into the matrix material. The remaining blend components were added and mechanically agitated. Total agitation included about 1 hour of mixing. The resultant pinstock blend was then extruded as a pinstock which was subsequently carbonized, densified and graphitized. Although a high degree of dispersion of the carbon fibers within the pitch volume can be achieved by this method, the carbon fiber-pitch mixture becomes much more viscous at the mixing temperature due to the thickening effect of the carbon fiber in the molten pitch. When the remaining blend components, including calcined coke particles and flour, were added to the viscous carbon fiber-pitch mixture, the method failed to disperse the carbon fibers though out the resultant pinstock blend. Thus, this method is only partially successful in attempts to fully disperse carbon fibers though out the carbon composite article.

What is needed is a method of fabricating carbon fiber reinforced carbon composite articles having a substantially uniform distribution of randomly oriented individual carbon fibers throughout the composite article.

Also, what is needed is a fabrication method that generally preserves the original lengths of the individual carbon fibers while dispersing carbon fibers in a substantially uniform and randomly oriented manner throughout a carbon fiber reinforced carbon composite article.

Finally, what is needed is a method of fabricating carbon fiber reinforced carbon composite articles so as to maximize the reinforcement properties of carbon fiber with respect to the degree individual carbon fibers are debundled and fully distributed throughout the composite article and with respect to the degree of preservation of the original lengths of the carbon fibers.

### BRIEF SUMMARY OF THE INVENTION

Carbon fiber reinforced carbon composite articles having a substantially uniform distribution of randomly oriented individual carbon mono-filaments (herein termed “carbon fibers”) can be fabricated by a process of mixing blend components, including carbon fiber bundles having a soluble sizing material, in a dispersing fluid so as to produce a slurry of blend components having the individual carbon fibers uniformly dispersed throughout. By selecting carbon fiber bundles that have a sizing material that is soluble in a selected solvent fluid, the carbon fibers can be substantially debundled by means of dissolving the sizing material. Additionally, a low viscosity fluid for mixing components can be used to form a slurry of blend components in which the individual carbon fibers are substantially randomly oriented and uniformly distributed throughout the slurry of blend components. For preferred embodiments, a single fluid (herein termed “dispersing fluid”) is used as both a solvent and as a fluid for mixing components. Once the carbon fibers are fully dispersed thought the slurry of blend components, the dispersing fluid may be removed either prior to or during the process of forming of the solids of the slurry into a carbon fiber reinforced carbon composite article.

The dispersing fluid used in this novel method is preferably water or other polar solvents such an alcohol. The preferred sizing materials are selected to be soluble in at least one such solvent. In one preferred embodiment, the sizing material is a water soluble polyamide.

In a preferred embodiment, carbon fiber bundles having a soluble sizing material are first mixed with a dispersing fluid so as to debundle the carbon fibers and uniformly disperse the individual carbon fibers throughout the resultant slurry. Next, other selected blend components, including a matrix material such as a pitch binder, are added to the slurry and mixed so as to produce a slurry of blend components having the individual carbon fibers fully dispersed throughout. In another preferred embodiment, the carbon fiber bundles are first combined with the other components of the blend and then the combination is mixed with the dispersing fluid so as form a slurry of blend components having the individual carbon fibers fully dispersed.

The blend components may be selected to promote mixing of the dispersion fluid with the blend components and to promote dispersion of the individual carbon fibers in the slurry of blend components. In one preferred embodiment, selection of powdered pitch provides for improved dispersion of matrix material within the slurry and provides for full dispersion of the individual carbon fibers in the slurry of blend components.

Processing parameters of the mixing steps, such as duration of mixing, and agitator shape and speed, may be selected so as to either preserve or reduce the length of the carbon fibers as desired. In some embodiments, there may be an optimization processing parameters and the selected properties of the carbon fibers within the composite as regards the dispersion of individual carbon fibers and the preservation of the carbon fiber length. Generally, selection of sufficient volume of dispersing fluid, more easily dispersed blend components, and sufficient original fiber length allow maximization of the reinforcement properties of the carbon fibers within the composite by providing for substantially full dispersion of the fibers and maintenance of at least a minimum fiber length.

Once the slurry of blend components is mixed and the individual carbon fibers fully dispersed, the dispensing fluid is then substantially removed by filtration, centrifugation, wringing, drying or any combination of heat and pressure. In a preferred embodiment the slurry is placed in a dewatering mold and subjected to selected slurry reduction temperatures and pressures. The reduced slurry mixture is then molded into a carbonizable precursor composite article. Preferably, the preform molding step is combined with the slurry reduction step or portions thereof. In one preferred embodiment, the slurry of blend components is placed in a mold and then subjected to selected slurry reduction temperatures and pressures for a first period so as to remove a substantial amount of the dispersing fluid and subsequently subjected to selected molding temperatures and pressures for a second period provide a carbonizable perform composite article having fully dispersed carbon fibers.

The carbonization step of the present invention may, as desired, be performed in conjunction with the steps of dewatering and/or molding. In one preferred embodiment, a slurry of blend components is placed within the cavity of a hot press mold. Pressure and resistive heating is applied in a pre-programmed fashion so as to first dewater, then mold and finally carbonize the blend of components into a carbonized precursor carbon composite. The steps of densification, graphitization and machining are then performed as desired.

An advantage of at least one embodiment of the present invention is that carbon fiber reinforced carbon composite articles fabricated in accordance with this novel method have a substantially uniform distribution of randomly oriented individual carbon fibers throughout the composite article.

Another advantage of at least one embodiment of the present invention is that this novel fabrication method generally preserves the original lengths of the individual carbon fibers while dispersing carbon fibers in a substantially uniform and randomly oriented manner throughout a carbon fiber reinforced carbon composite article.

A third advantage of at least one embodiment of the present invention is that this novel fabrication method generally maximizes the reinforcement properties of carbon fiber with respect to the degree individual carbon fibers debundling and full distribution throughout the composite article and with respect to the degree of preservation of the original lengths of the carbon fibers and maintenance of at least a minimum fiber length.

Still further advantages of the present invention will be readily apparent to those skilled in the art, upon a reading of the following disclosure

### DETAILED DESCRIPTION OF THE INVENTION

In a preferred embodiment of the present invention, carbon fiber reinforced carbon composite articles having a substantially uniform distribution of randomly oriented carbon fiber filaments can be fabricated by a process of first mixing selected carbon fiber bundles having a soluble sizing material in a selected dispersing fluid for a first period so as to debundle the carbon fibers and uniformly disperse the individual carbon fibers throughout the resultant slurry. Next, other selected blend components, including a matrix material such as a pitch binder, are added to the slurry and mixed for a second period so as produce a slurry of blend components having the individual carbon fibers uniformly dispersed throughout. In another preferred embodiment of the present invention, such a carbon fiber reinforced carbon composite articles can be fabricated a process of first combining the carbon fiber bundles with the other components of the blend and then mixing the combination with the dispersing fluid so as form a slurry of blend components having the individual carbon fibers fully dispersed. The scope of the present invention also includes embodiments similar to these two preferred embodiments wherein unbundled carbon fibers are substituted for the selected carbon fiber bundles of the blend components.

According to the present invention, useful carbon fibers include, but not by way of limitation, pitch-based carbon fibers, mesophase pitch-based carbon fibers, isotropic pitch-based carbon fibers, polyacrylonitrile-based carbon fibers, rayon and combinations thereof The scope of the present invention also includes embodiments directed towards formation of carbon composite bodies wherein carbon fibers are selected for properties other than reinforcement of the composite body and wherein it is desired that such carbon fibers be substantially randomly oriented and uniformly distributed throughout the composite body or portions thereof

According to a preferred embodiment of the present invention, carbon fiber bundles are selected for their reinforcement properties and for the characteristics of the sizing materials used to compact and bind the carbon fiber into bundles. As discussed above, the sizing materials are selected for their solubility in various solvents. The reinforcement properties of the carbon fibers are determined by, among other things, the fiber length and the adhesive properties of the fiber surfaces to the selected matrix materials. The adhesive properties of the carbon fibers may be enhanced by surface treatment of the fibers. One skilled in the art of forming carbon-carbon bodies may select the type of carbon fibers, a minimum fiber length and the surface treatment of the fibers so as to optimize the adhesive properties desired for the component carbon fibers.

In one preferred embodiment of the present invention, each carbon fiber bundle has a length of between about 5 mm and about 40 mm and includes between about 2,000 and about 50,000 carbon fibers. In a more preferred embodiment of the present invention the selected carbon fiber bundles include between about 2,000 and about 20,000 carbon fibers compacted and bound by a soluble sizing material. So long as it is desired that carbon fibers of a composite body be substantially randomly oriented and uniformly distributed throughout the body or portions thereof, the scope of the present invention also includes embodiments wherein the selected carbon fiber bundles have lengths either greater than about 40 mm or less than about 5 mm and includes embodiments wherein the carbon fibers bundles have either greater than about 50,000 carbon fibers or less than about 2,000 carbon fibers, all as selected by one skilled in the art of forming carbon fiber composites.

According to the present invention, carbon fiber are provided in an amount between about 0.5% and about 80% by weight of the total amount of blend components, such carbon fibers being provided preferably as carbon fiber bundles. In one preferred embodiment of the present invention directed toward the formation of a carbon fiber reinforced graphite electrode or pin, selected carbon fibers are provided in an amount between about 0.5% and about 10% by weight of the total amount of blend components. In another preferred embodiment of the present invention directed toward the formation of a carbon fiber reinforced carbon compacts such as brake pads, selected carbon fibers are provided in an amount between about 20% and about 50% by weight of the total amount of blend components.

In a preferred embodiment of the present invention, the dispersing fluid is water or other polar solvents such as ethanol or other alcohols and the sizing material of the selected carbon bundles is soluble in water or in such other polar solvents. In a more preferred embodiment, the sizing material is water soluble and the dispersing fluid is water. In one more preferred embodiment, the sizing material is a water soluble polyamide.

According to the present invention, the dispersing fluid is provided in amounts (herein termed dispersing volumes) sufficient to dissolve the sizing material of the carbon fiber bundles and to uniformly disperse the individual carbon fibers throughout the slurry of blend components. In one embodiment the dispersing fluid is provided in a dispersing volume sufficient to dissolve the sizing material and disperse the individual carbon fibers throughout the fluid volume. During subsequent addition and mixing of the other blend components, the mechanical agitation of mixing distributes the dispersing fluid and the dispersed fibers it carries over the other blend components such that a slurry is produced. In this embodiment, significantly agitation may be required to produce a slurry of blend components having individual carbon fibers fully distributed throughout. Moreover, the intensity of agitation and the time of total agitation may break at least a portion of the individual carbon fibers and thus reduce the original carbon fiber lengths.

In a preferred embodiment, the dispersing fluid is provided in a dispersing volume sufficient to disperse the individual carbon fibers throughout the dispersing fluid volume and sufficient to disperse at least a portion of the other blend components throughout the slurry of blend components. In this embodiment, mixing of the blend components and dispensing fluid produces a less granular or viscous slurry of blend components and the carbon fibers are readily fully dispersed throughout the slurry. Generally, this embodiment of the present invention requires less intensity of agitation and a shorter time of total agitation and is therefore less likely to break a significant portion of the individual carbon fibers.

According to the present invention, the blend components may be selected to promote mixing of the dispersion fluid with the blend components and to promote dispersion of the individual carbon fibers in the slurry of blend components. In one preferred embodiment, selection of powdered and floured blend components provides for improved dispersion of the other blend components within the slurry and provides for full dispersion of the individual carbon fibers in the slurry of blend components. In a particularly preferred embodiment, a powdered binder, such as a powdered pitch or a powdered phenol or furan, is used with water to form a slurry of blend components having fully dispersed individual carbon fibers. Such a slurry of blend components is particularly useful in further forming a de-watered mixture having fully dispersed carbon fibers for either molding into a carbonizable (or “green stock”) precursor article or for forming a carbonized carbon composite by means of hot pressing.

According to the present invention, processing parameters of the mixing steps may be selected so as to either preserve or reduce the length of the carbon fibers as desired. As used herein, processing parameters include, but are not limited to: the type of mixing device; the agitator shape; the agitation speed; the mixing periods; and the percentage ratio (herein termed the dispersing ratio) of the volume of dispersing fluid to the volume equivalent (herein termed the fiber volume) of the carbon fibers provided, if the carbon fibers were provided in an unbundled state. In one preferred embodiment the dispersing fluid is water and the dispersing ratio is at least about 200%.

The slurry reduction (or “dewatering”) step of the present invention includes removal of a substantial amount of the dispersing fluid and may be accomplished by any of a number of means. For example, such fluid may be removed by filtration, centrifugation, wringing, drying or any combination of heat and pressure that will not affect the physical or chemical characteristics of the blend components remaining in the “reduced” mixture. In a preferred embodiment the slurry of blend components is placed in a dewatering mold and subjected to selected slurry reduction temperatures and pressures for a first period so as to remove a substantial amount of the dispersing fluid so as to provide a carbonizable mixture having fully dispersed carbon fibers. In another preferred embodiment, a first portion of the fluid within the slurry of blend components is removed by means of filtration, centrifugation or wringing. Then a second portion of the fluid is removed by dewatering in a dewatering mold as described above.

The perform molding step of the present invention includes molding the blend components of the reduced slurry mixture into a carbonizable precursor composite article. Preferably, the preform molding step is combined with the slurry reduction step or portions thereof. In a preferred embodiment, the slurry of blend components is placed in a dewatering and performing mold and subjected to selected slurry reduction temperatures and pressures for a first period so as to remove a substantial amount of the dispersing fluid and subsequently subjected to selected molding temperatures and pressures for a second period provide a carbonizable perform composite article having fully dispersed carbon fibers. In one preferred embodiment, the mold is an extrusion mold having both dewatering and extrusion portions. In another preferred embodiment, the mold is adapted to receive the slurry of blend components; heat or compress the slurry at said selected reduction temperatures and pressures for said first period; and then heat or compress the resultant reduced slurry mixture at said selected molding temperatures and pressures for said subsequent second period so as to produce a carbonizable perform article. In a more preferred embodiment, such selected periods of time, temperatures and pressures are pre-programmed times, temperatures and pressures.

The carbonization step of the present invention may be performed separately or may be performed in conjunction with the performance of molding step and/or the slurry reduction step. In one preferred embodiment, an at least partially dewatered slurry of blend components is placed within the cavity of a hot press mold. Pressure and resistive heating is applied in a pre-programmed fashion so as to first dewater, then mold and finally carbonize the blend of components into a carbonized precursor carbon composite.

The present invention also includes the subsequent steps of densification, graphitization and machining so as to provide properly dimensioned carbon fiber reinforced carbon composite articles. The resulting carbon fiber reinforced carbon composite articles are suited to a wide range of applications, including: brake components; antiskid components; structural components, such as body panels; pistons and cylinders, for vehicles, such as aircraft, high performance cars, trains, and aerospace vehicles; and missile components.

The scope of the present invention also includes embodiments wherein the carbonization, densification, and graphitization steps are omitted and alternate curing processes, such as thermosetting, are employed. This aspect of the present invention is particularly applicable embodiment having phenol and furan based binders as elements of the blend components.

### EXAMPLES

Two trials were conducted using bundles of mesophase pitch based carbon fiber (herein MPCF) designated as Grade K 223-SE obtained from Mitsubishi Chemical Company of Tokyo, Japan. The fibers were compacted into bundles of about 12,000 fibers with a sizing and chopped into lengths of about 6 mm. Composition A was the product of the first trial and Composition B was the product of the second. In each trial, MPCF was selected for its readily dispersible nature, which is attributable to the water soluble sizing used to compact and bind the MPCF carbon fiber bundles. In the first trial, MPCF carbon fiber bundles were provided at about 28% by weight of total blend components. In the second trial, that weight percentage was reduced to about 14%.

For each trial, blend components, including the MPCF bundles and a binder flour, were added to a selected mixing device. Next, water was selected as the dispersing fluid and provided to each mixing device in an amount equal to a dispersing ratio of about 2 multiplied by the fiber volume of the trial. In the first trial the combination of water and blend components was mixed at high speed for between about 30 seconds and about 5 minutes. The components for trial 2 were mixed at low speed for a similar period of time. Following the mixing step, a substantial portion of the water was removed from the slurry of blend components by such readily available means, including filtration, centrifugation, drying and combination of heat and pressure that will not affect the blend components.

After the dewatering step, the resultant Composition A and Composition B were both acceptable as green stock mixtures ready for molding into a precursor carbon composite. Analysis of Composition A indicated that the average fiber length had been reduced from about 6 mm to about 1 mm. In contrast, an analysis of Composition B indicated that the average fiber length had been preserved at about 6 mm. This was attributed to the difference in selected mixing speed. Microscopic analysis confirmed that both Compositions A and B had substantially full dispersion of the individual carbon fibers throughout the green stock mixture.

Thus, although there have been described particular embodiments of the present invention of a new and useful Method for Debundling and Dispersing Carbon Fiber Filaments Uniformly Throughout Carbon Composite Compacts Before Densification, it is not intended that such references be construed as limitations upon the scope of this invention except as set forth in the following claims.

What is claimed is:

1. A method of making a precursor carbon fiber reinforced carbon composite article, the method comprising the steps of:
(a) providing a plurality of blend components, including
carbon fiber bundles, each bundle comprising carbon fibers bound by a sizing material; and
a matrix material;
(b) providing a dispersing fluid adapted to dissolve the sizing material;
(c) forming a slurry by combining the dispersing fluid and the blend components;
(d) removing at least a portion of the dispersing fluid so as to form a precursor mixture; and
(e) molding the precursor mixture so as to form a precursor carbon fiber reinforced carbon composite article wherein said carbon fibers are generally randomly oriented and uniformly dispersed through out the article.

2. The method of claim 1, wherein said sizing material comprises a water-soluble sizing material, and
wherein said dispersing fluid comprises water.

3. The method of claim 2, wherein said water-soluble sizing material comprises a water-soluble polyamide.

4. The method of claim 1, wherein said sizing material comprises a sizing material soluble in a selected polar solvent, and
wherein said dispersing fluid comprises said selected polar solvent.

5. The method of claim 4, wherein said selected polar solvent comprises an alcohol.

6. The method of claim 5, wherein said alcohol comprises ethanol.

7. The method of claim 1, wherein generally each said carbon fiber bundle comprises between about 2,000 and about 50,000 carbon fibers.

8. The method of claim 7, wherein generally each said carbon fiber bundle comprises about 2,000 and about 20,000 carbon fibers.

9. The method of claim 1, wherein said carbon fiber bundles comprise carbon fibers selected from the group including: pitch-based carbon fibers, mesophase pitch-based carbon fibers, isotropic pitch-based carbon fibers, polyacrylonitrile-based carbon fibers, rayon and combinations thereof.

10. The method of claim 1, wherein generally each said carbon fiber bundle has a length of between about 5 mm and about 40 mm.

11. The method of claim 1, wherein step (a) includes providing carbon fiber bundles in an amount between about 0.5% and about 50% by weight of the blend components.

12. The method of claim 1, wherein step (b) includes providing at least about a dispersion volume of dispensing fluid.

13. The method of claim 12, wherein the amount of carbon fibers provided in step (a) defines a fiber volume, and
wherein the dispersion volume provided in step (b) is equal to at least about a dispersing ratio multiplied by said fiber volume.

14. The method of claim 13, wherein the dispersing ratio is at least about 200%.

15. The method of claim 1, wherein step (c) comprises the steps of:
mixing the carbon fiber bundles and the dispersion fluid for a first period of time such that the sizing material generally dissolves and such that the debundled carbon fibers generally disperse throughout the dispersion fluid so as to form a resultant mixture; and
mixing the resultant mixture and the remainder of the blend components for a second period of time so as to form a slurry.

16. The method of claim 1, wherein step (c) comprises:
mixing the blend components, including the carbon fiber bundles so as to form a dry mix;
mixing the dispersion fluid and the dry mix for a first period of time so as to form a slurry having carbon fibers generally randomly oriented and uniformly dispersed throughout.

17. A method of making a precursor carbon composite mixture, the method comprising the steps of:
(a) providing a plurality of blend components, including
carbon fiber bundles in an amount between about 0.5% and about 50% by weight of the blend components, wherein generally each said carbon fiber bundle comprises between about 2,000 and about 50,000 carbon fibers bound by a water soluble sizing material; and
a matrix material;
(b) providing at least a dispersing volume of water;
(c) forming a slurry by combining the water and the blend components; and
(d) removing at least a portion of the water so as to form a precursor carbon composite mixture wherein said carbon fibers are generally randomly oriented and uniformly dispersed throughout the mixture.

18. The method of claim 17, wherein step (c) comprises the steps of:
mixing the carbon fiber bundles and the dispersion fluid for a first period of time such that the sizing material generally dissolves and such that the debundled carbon fibers generally disperse throughout the dispersion fluid so as to form a resultant mixture; and
mixing the resultant mixture and the remainder of the blend components for a second period of time so as to form a slurry.

19. The method of claim 17, wherein step (c) comprises:
mixing the blend components, including the carbon fiber bundles so as to form a dry mix;
mixing the dispersion fluid and the dry mix for a first period of time so as to form a slurry having carbon fibers generally randomly oriented and uniformly dispersed throughout.

20. A method of making a carbon fiber reinforced carbon composite article, the method comprising the steps of:
(a) providing a plurality of blend components, including
carbon fiber bundles in an amount between about 0.5% and about 50% by weight of the blend components, wherein generally each said carbon fiber bundle comprises between about 2,000 and about 20,000 carbon fibers bound by a water soluble sizing material; and
a matrix material;
(b) providing at least a dispersing volume of water;
(c) forming a slurry by combining the water and the blend components;
(d) removing at least a portion of the water so as to form a precursor mixture wherein said carbon fibers are generally randomly oriented and uniformly dispersed throughout the mixture;
(e) molding the precursor mixture so as to form a precursor carbon composite article; and
(f) carbonizing the precursor carbon composite article; and
(g) graphitizing the carbonized article so as to form a carbon fiber reinforced carbon composite article.

21. The method of claim 20, wherein the blend components comprise at least one floured or powdered blend component.

22. The method of claim 20, wherein the matrix material comprises floured or powdered pitch.

23. The method of claim 20, further including the step of densification.

24. The method of claim 20, wherein steps (d) , (e) and (f) are performed by means of compressive and resistive heating.
